(19) United States
(12) Patent Application Publication
(10) Pub. No.: US 2003/0048201 A1
(43) Pub. Date: Mar. 13, 2003

(54) Method and apparatus for early warning traffic signal

(76) Inventors: Anre F Weiss, Sonoma, CA (US); Reet Weiss, Sonoma, CA (US)

Correspondence Address: Craig M. Stainbrook, Johnson & Stainbrook, 3550 Round Bark Blvd.,, Suite 203, Santa Rosa, CA, 95403-0921, US

(21) Appl. No.: 09/936,801

(22) PCT Filed: Jan. 12, 2001
(86) PCT No.: PCT/US01/02052

(30) Foreign Application Priority Data
Jan. 12, 2000 (US) 60175798

(51) Int. Cl. G08G 1/096

(52) U.S. Cl. 340/929; 340/907; 340/925

(57) ABSTRACT

A method and apparatus to alert motorists of an impending change of a traffic signal includes a traffic signal assembly (10) including individual red, yellow and green signal lights, with control circuitry (2) to sequentially illuminate the green signal light as a constant green for a first portion T1a of time interval T1, followed by a flashing green for a second portion T1b of interval T1, after which the yellow signal illuminates for time T2, the red signal for a time T3, and the cycle repeats. Thus, instead of the green light remaining constantly illuminated during its entire period of timed operation, the modified circuitry causes the green light to flash for the last portion of its operation, thereby indicating to the motorist that the signal is about to change to yellow.

### DESCRIPTION

1. Technical Field

This invention relates generally to traffic control devices, and more specifically to an improved method and apparatus for providing an early warning traffic signal to alert drivers to an impending change of a traffic signal.

2. Background Art

Traffic signals and other traffic control systems are commonly used at roadway intersections in an effort to safely and efficiently control traffic flow. Simple signage such as stop signs and yield signs may be used at relatively low-volume intersections, while illuminated traffic signals may be used at those intersections with higher volumes of traffic. Typical illuminated traffic signals consist of light assemblies including individual signal lights having different colors, e.g., red, yellow, and green, which assemblies are mounted on a pole or suspended by wires adjacent to or over the intersection being controlled.

In most jurisdictions compliance with these various control systems is mandated by law. For example, a continuous red light at an intersection normally prohibits the motorist from entering into the intersection until the red light is replaced by a green light, at which time the motorist can proceed through the intersection. Normally, a yellow (or amber) light is sequentially displayed for an interval after the green light interval and before the red light interval for the purpose of warning motorists that only a limited time remains to traverse the intersection before their light will turn red, and cross traffic will be permitted to enter the intersection pursuant to their own green signal.

The yellow light interval is normally long enough to permit a motorist to either drive completely through the intersection before the red light interval, or to stop before entering the intersection. Thus, if a motorist is in or very near the intersection when the yellow signal first appears, the motorist can probably safely traverse the intersection at normal traffic speed. Conversely, if the motorist is still some distance from the intersection when the yellow light interval is initiated. the motorist should stop before entering the intersection.

In practice, however, use of the intervening yellow signal has created its own set of problems. For example, a motorist proceeding toward an intersection and seeing a yellow signal must quickly decide whether to stop before the intersection or proceed through it. Depending upon where the motorist is relative to the intersection when he or she first observes the yellow signal, and numerous other factors such as vehicle speed, road conditions, driver skill, and the like, it may be difficult or even impossible to safely stop before entering the intersection. On the other hand, and again depending upon the same factors, it may be difficult or impossible to clear the intersection before the light changes to red. Either scenario presents potentially dangerous consequences.

Numerous proposals have been made to remedy this situation. For example, while extending the duration of the yellow light interval would permit more time for a motorist to traverse the intersection, it would also encourage aggressive drivers to attempt to take advantage of the extended duration and drive right through all yellow signals. Providing an interval between one traffic direction's red signal and the other direction's green signal would almost certainly improve safety, but at a cost of reduced traffic efficiency while all motorists are simultaneously stopped at the intersection.

Accordingly, it is an object of this invention to provide a method and apparatus to alert approaching motorists when a traffic signal is about to change from green to yellow.

It is a further object of this invention to provide an early warning traffic signal for motorists so that they can better prepare for a stop.

It is a still further object of this invention to reduce the risk of motorists running a red traffic light and possibly colliding with other vehicles at intersections.

### DISCLOSURE OF INVENTION

The early warning traffic signal of this invention provides a method and apparatus to alert motorists of an impending change of a traffic signal. The apparatus includes a more or less standard traffic signal assembly including individual red, yellow and green signal lights, adapted for mounting on a pole or suspension by wires adjacent to or over the intersection being controlled. Timing and control circuitry is provided which sequentially illuminates the signal lights in a predetermined and programmable order and duration, e.g., the green signal light is illuminated for a time interval T1, followed by the yellow signal light for a time interval T2, followed by the red signal light for a time interval T3, then repeating the cycle green-yellow-red for as long as the operation is desired, all as is well known and practiced in the art.

The inventive apparatus provides a modification to the timing and control circuitry to intermittently flash the green signal during only a predetermined last portion of its interval of illumination, e.g., constant green illumination for a first portion T1a of interval T1, followed by flashing green illumination for a second portion T1b of interval T1, after which the yellow signal illuminates for time T2, and the cycle repeats as above. Thus, instead of the green light remaining steady on (constantly illuminated) during its entire period of timed operation, the modified circuitry causes the green light to flash for the last portion of its operation, thereby indicating to the motorist that the signal is about to change to yellow. This signaling effect is simple for the motorist to understand, and the flashing effect additionally serves to capture the motorist's attention.

The inventive apparatus may take the form of original equipment, that is, a newly manufactured signal light with the modified control and timing circuitry installed. Alternatively, and in the preferred embodiment, the invention can be retrofit to existing traffic signals by incorporation of a supplemental flash circuit interposed into the existing control wiring to the green light. Finally, the inventive method can be implemented with either the original equipment or retrofit embodiments.

### BRIEF DESCRIPTION OF THE DRAWINGS

FIG. 1 is a schematic view of a prior art traffic signal; and

FIG. 2 is a schematic view of an early warning traffic signal apparatus of this invention.

### BEST MODE FOR CARRYING OUT THE INVENTION

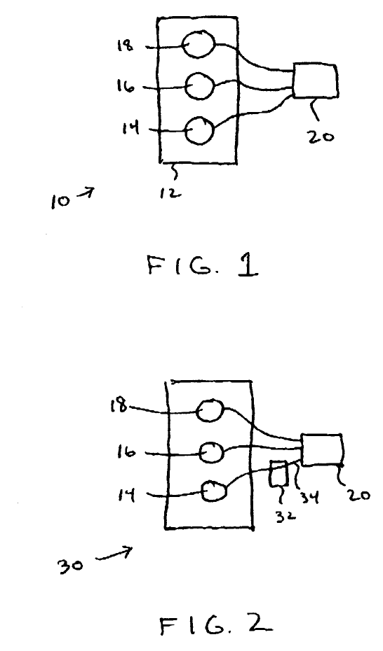

FIG. 1 is a schematic view of a prior art traffic signal 10. This view illustrates a traffic signal assembly 12 including individual green, yellow and red signal lights 14, 16, and 18, respectively. Timing and control circuitry 20 sequentially illuminates the signal lights in a predetermined and programmable order and duration, e.g., the green signal light 14 is illuminated for a time interval T1 (e.g., thirty seconds), followed by the yellow signal light 16 for a time interval T2 (e.g., five seconds), followed by the red signal light 18 for a time interval T3 (e.g., thirty seconds), then repeating the cycle green-yellow-red for as long as the operation is desired.

FIG. 2 is a schematic view of an early warning traffic signal apparatus 30 of this invention. The inventive apparatus provides a modified timing and control circuitry or flash circuit 32 adapted to intermittently flash the green signal 14 during only a predetermined last portion of its interval of illumination, e.g., constant green illumination for a first portion T1a of interval T1, followed by flashing green illumination for a second portion T1b of interval T1, after which the yellow signal 16 illuminates for time T2, and the cycle repeats as above. Thus, instead of the green light 14 remaining steady on (constantly illuminated) during its entire period of timed operation, the modified circuitry 32 causes the green light to flash for the last portion of its operation, thereby indicating to the motorist that the signal is about to change to yellow.

In the preferred embodiment, timing and control circuitry 32 is simply retrofit to existing traffic signals by being interposed into the control wiring 34 from circuitry 20 to green light 14, such that when activation of green light 14 is initiated through wiring 34, timing and control circuitry 32 acts to permit constant illumination of green light 14 for interval T1a, then acts to periodically interrupt (flash) illumination of green light 14 for interval T1b. Such retrofit could be accomplished with easily available hardware, by techniques well known in the art, and be powered by the existing traffic signal power supply. Alternatively, the inventive circuitry could be implemented into originally manufactured traffic signals, in which event the schematic would appear just as in FIG. 1.

While this invention has been described in connection with preferred embodiments thereof, it is obvious that modifications and changes therein may be made by those skilled in the art to which it pertains without departing from the spirit and scope of the invention. Accordingly, the scope of this invention is to be limited only by the appended claims and equivalents.

What is claimed as invention is:

1. An early warning traffic signal apparatus to alert motorists of an impending change of a traffic signal, said apparatus comprising:
A traffic signal assembly including individual red, yellow and green signal lights;
Timing and control circuitry adapted to sequentially illuminate said signal lights as follows; constant illumination of said green signal during a first portion T1a of a time interval T1, followed by flashing green illumination for a second portion T1b of time interval T1, followed by said yellow signal light for a time interval T2, followed by said red signal light for a time interval T3, then repeating the cycle green-yellow-red.

2. The early warning traffic signal apparatus of claim 1 wherein said apparatus is retrofit to existing traffic signals by incorporation of a supplemental flash circuit interposed into the existing control wiring to the green light.

3. A method for early warning of an impending change of a traffic signal, said method comprising the steps of:
Providing a traffic signal assembly including individual red, yellow and green signal lights;
Providing timing and control circuitry adapted to sequentially illuminate said signal lights as follows; constant illumination of said green signal during a first portion T1a of a time interval T1, followed by flashing green illumination for a second portion T1b of time interval T1, followed by said yellow signal light for a time interval T2, followed by said red signal light for a time interval T3, then repeating the cycle green-yellow-red.
